(19) United States
(12) Patent Application Publication
(10) Pub. No.: US 2026/0354314 A1
(43) Pub. Date: Nov. 12, 2026

(54) Self-learning non-integrated luminaire

(71) Applicant: SIGNIFY HOLDING B.V., EINDHOVEN (NL)

(72) Inventors: MATHAN KUMAR GOPALSAMY, MEDFORD, MA (US); JAEHAN KOH, CHESTNUT HILL, MA (US)

(21) Appl. No.: 19/123,927

(22) PCT Filed: Oct. 30, 2023
(86) PCT No.: PCT/EP2023/080173

§ 371 Date: Apr. 24, 2025

Related U.S. Application Data
(60) Provisional application No. 63/421,646, filed on Nov. 2, 2022.

(30) Foreign Application Priority Data
Dec. 5, 2022 (EP) 22211307.8

(51) Int. Cl. A01G 7/04; G06N 3/092; H05B 47/11

(52) U.S. Cl. CPC A01G 7/045; G06N 3/092; H05B 47/11

(57) ABSTRACT

A non-integrated luminaire (100) is arranged in a horticultural environment (HE). The non-integrated luminaire includes light sources (102) and a controller (104). The light sources provide illumination and influence environmental parameters (106) of the horticultural environment based on one or more lighting properties. The lighting properties may include light spectrum, light intensity, spatial location, and/or light direction. The controller is communicatively coupled to sensors (110). The sensors measure the environmental parameters. The sensors include at least one of an ambient temperature sensor (112) or a plant temperature sensor (116). The controller generates an optimized lighting recipe based on the measured environmental parameters and an optimization model. The optimization model computes a weighted average of differences based on the measured environmental parameters recorded during modifications of the one or more lighting properties. The controller also adjusts the one or more lighting properties according to the optimized lighting recipe.

### FIELD OF THE DISCLOSURE

The present disclosure is directed generally to systems and methods for providing optimized illumination from one or more non-integrated luminaires based on measured environmental parameters surrounding the luminaires. More specifically, the present disclosure is directed to self-learning non-integrated luminaires and self-learning non-integrated luminaires to optimally illuminate a horticultural environment based on measured environmental parameters.

### BACKGROUND

Legalization and decriminalization of cannabis throughout the United States is expected to significantly increase the market for home and small farm growers. These home and small farm growers include growers using indoor or enclosed growing areas, such as small greenhouses or grow rooms. In large farms, lighting systems are typically integrated with other farm systems, such as heating, ventilation, and air conditioning (HVAC) systems. Integrating the lighting system with the HVAC system enables both systems to optimize their impact on the plants growing inside a horticultural environment. For example, in an integrated system, the lighting and HVAC systems may be coordinated such that grow room temperature follows day and night setpoints with minimal variance due to the integrated systems quickly adjusting to measured deviations in temperature due to the richness of information provided by sensors and controls of the integrated sub-systems.

However, home and small farm growers often lack the resources to integrate lighting systems with HVAC systems, and typically rely on off-the-shelf, non-integrated luminaires. Such non-integrated grow rooms often operate sub-optimally. For example, an illumination schedule may turn on the non-integrated luminaires at full capacity without considering subsequent effects on the HVAC system's cooling load (power required to remove excess heat) and plant stress, resulting in rapid increases in illumination and temperature negatively impacting the plants being grown. It is estimated that 50% (in the case of light emitting diode (LED) luminaires) to 62% (in the case of high-pressure sodium (HPS) luminaires) of heat energy is typically trapped in a grow room. This trapped heat eventually becomes the cooling load of the HVAC system. In addition, research has shown that asynchronous fluctuations in light and temperature regimes not only affect processes at the molecular level of a plant, but also lead to changes in morphological traits at the level of the whole plant. It has also been shown that plant stress was observed under fixed light conditions in combination with variable temperatures. These results suggest that plant productions and experiments should avoid applying constant levels of light in fluctuating temperature environments (i.e., greenhouses). Additionally, unnecessary heat gain also results in higher energy costs and a larger carbon footprint. Accordingly, there is a need in the art for improved systems and methods for implementing non-integrated luminaires in home and small farm environments.

### SUMMARY OF THE DISCLOSURE

The present disclosure is directed generally to self-learning, non-integrated luminaires and, more specifically, to self-learning, non-integrated luminaires that are configured to optimally illuminate a horticultural environment based on measured environmental parameters surrounding the luminaires. The non-integrated luminaires include one or more light sources, such as light emitting diode (LED) or high-pressure sodium (HPS) light sources. The light sources are configured to illuminate one or more plants (or a plant canopy) within the horticultural environment. The light sources may be arranged in a variety of configurations, such as in a top light- or grid light-configuration, but any suitable configuration is contemplated. The horticultural environment may be a greenhouse, grow room, growth chamber, or other indoor and/or enclosed agricultural space.

The non-integrated luminaire contemplated herein also includes a controller. The controller is communicatively coupled to sensors configured to measure environmental parameters within the horticultural environment. In some examples, one or more of the sensors may be embedded within the non-integrated luminaire. In some other examples, one or more of the sensors may be arranged externally to the non-integrated luminaire, such as proximate to one or more of the plants within the horticultural environment. The external sensors may provide the measured environmental parameters to the controller via or using a wired or wireless connection. The sensors may include an ambient temperature sensor, a plant temperature sensor (such as a thermal camera), and/or a light sensor (such as a multi-spectral camera or a photosynthetically active radiation (PAR) sensor). The environmental parameters may be measured continuously, at predetermined time intervals, or otherwise.

The controller then feeds the measured environmental parameters into an optimization model to generate an optimized lighting recipe. The optimized lighting recipe sets one or more lighting properties of the non-integrated luminaire. The lighting properties may include light spectrum, light intensity, spatial location, light direction, etc. These lighting properties may be wavelength dependent, such as varying light intensity or light direction over a range of light wavelengths. The lighting properties then dictate the illumination provided by the one or more light sources of the non-integrated luminaire. The optimization model may be a reinforcement machine learning model, such as a multi-armed bandit (MAB) problem model. These reinforcement machine learning models are configured to continually determine optimum lighting properties resulting in improved measured environmental parameters. For example, the optimization model may determine the optimized light intensity level to reduce ambient and plant temperatures to a safe level for the plants of the horticultural environment. In other examples, the optimization model may determine the optimized lighting recipe based on user feedback corresponding to a user's assessment of plant health and ambient temperature.

Unlike integrated luminaires, the non-integrated luminaire is not communicatively coupled to other systems operating within the horticultural environment, such as a heating, ventilation, and air conditioning (HVAC) system. However, the non-integrated luminaire may be communicatively coupled, such as by a wired or wireless connection, to additional non-integrated luminaires within the horticultural environment. The non-integrated luminaires may exchange information, such as lighting properties, measured environmental parameters, or optimized lighting recipes, with each other for further optimization.

Generally, in one aspect, a non-integrated luminaire is provided. The non-integrated luminaire is arranged in a horticultural environment. According to some examples, the non-integrated luminaire may be a top light or a grid light.

The non-integrated luminaire includes one or more light sources. The one or more light sources are configured to provide illumination and influence one or more environmental parameters of the horticultural environment based on one or more lighting properties. According to an example, at least one of the one or more light sources is an LED or an HPS light. According to an example, the one or more lighting properties include a light spectrum, a light intensity, a spatial location, and/or a light direction. At least one of the one or more lighting properties may be wavelength dependent.

The non-integrated luminaire further includes a controller. The controller is communicatively coupled to one or more sensors. The one or more sensors are configured to measure the one or more environmental parameters. The one or more sensors include at least one of an ambient temperature sensor or a plant temperature sensor. The ambient temperature sensor is configured to measure ambient temperature data. The plant temperature sensor is configured to measure plant temperature data. According to an example, the plant temperature sensor may be a thermal camera, single pixel thermopile sensor, or a multi-pixel thermopile array.

The controller is configured to generate an optimized lighting recipe. The optimized lighting recipe is based on the measured environmental parameters and an optimization model. The optimization model is configured to compute a weighted average of differences. The weighted average of differences is based on the measured environmental parameters recorded during modifications of the one or more lighting properties. The optimization model may be a reinforcement learning model. According to an example, the optimized lighting recipe may be generated further based on user feedback received by the controller.

The controller is further configured to adjust the one or more lighting properties. The one or more lighting properties are adjusted according to the optimized lighting recipe.

According to an example, the one or more sensors may include a light sensor. The light sensor may be configured to measure spectral data. The light sensor may be a multi-spectral camera or a photosynthetically active radiation (PAR) sensor.

According to an example, the controller may be further configured to receive, via a wired or wireless connection, a second optimized lighting recipe from a second non-integrated luminaire. The adjusting of the one or more lighting properties may be further based on the second optimized lighting recipe.

According to an example, the controller is further configured to transmit, via the wired or wireless connection, the optimized lighting recipe to the second non-integrated luminaire.

According to an example, the one or more environmental parameters are provided to the controller according to a predetermined time interval.

Generally, in another aspect, a method of illuminating a horticultural environment is provided. The method includes providing a non-integrated luminaire. The non-integrated luminaire includes one or more light sources to provide illumination and influence one or more environmental parameters of the horticultural environment based on one or more lighting properties. The non-integrated luminaire further includes a controller communicatively coupled to one or more sensors configured to measure the one or more environmental parameters. The one or more sensors include at least one of an ambient temperature sensor configured to measure ambient temperature data or a plant temperature sensor configured to measure plant temperature data.

The method further includes measuring, via the one or more sensors, the one or more environmental parameters of the horticultural environment.

The method further includes generating, via the controller, an optimized lighting recipe based on the measured environmental parameters and an optimization model. The optimization model is configured to compute a weighted average of differences based on the measured environmental parameters recorded during modifications of the one or more lighting properties.

The method further includes adjusting, via the controller, the one or more lighting properties according to the optimized lighting recipe. In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an illustration of two non-integrated luminaires arranged in a horticultural environment, according to aspects of the present disclosure.

FIG. 2A is a graph showing temperature in a horticultural environment utilizing integrated luminaires, according to aspects of the present disclosure.

FIG. 2B is a graph showing temperature in a horticultural environment utilizing non-integrated luminaires, according to aspects of the present disclosure.

FIG. 3 is an isometric view of a top light, according to aspects of the present disclosure.

FIG. 4 is a bottom view of a grid light, according to aspects of the present disclosure.

FIG. 5 is a block diagram of a non-integrated luminaire and related devices, according to aspects of the present disclosure.

FIG. 6 is a schematic diagram of a controller of a non-integrated luminaire, according to aspects of the present disclosure.

FIG. 7 is a flowchart of a method of illuminating a horticultural environment, according to aspects of the present disclosure.

### DETAILED DESCRIPTION OF EMBODIMENTS

The present disclosure is directed generally to self-learning, non-integrated luminaires and, more specifically, to self-learning, non-integrated luminaires that are configured to optimally illuminate a horticultural environment based on measured environmental parameters surrounding the luminaires. The non-integrated luminaire includes one or more light sources to illuminate one or more plants (or a plant canopy) within the horticultural environment. The non-integrated luminaire also includes a controller. The controller is communicatively coupled to sensors configured to measure environmental parameters within the horticultural environment and under the influence of the light sources of the non-integrated luminaire. The controller then feeds the measured environmental parameters into an optimization model to generate an optimized lighting recipe. The optimization model is configured to compute a weighted average of differences based on the measured environmental parameters recorded during modifications of the one or more lighting properties. The optimized lighting recipe sets one or more lighting properties of the non-integrated luminaire. The lighting properties then dictate the illumination provided by the one or more light sources of the non-integrated luminaire. The optimization model may be a reinforcement machine learning model. The non-integrated luminaire may also be communicatively coupled to additional non-integrated luminaires within the horticultural environment to exchange information for further optimization.

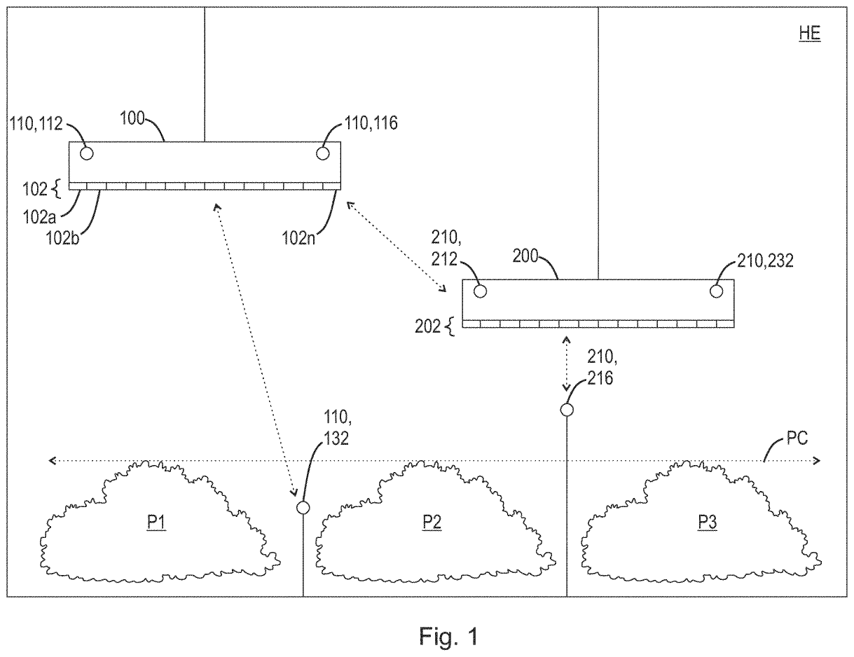

Referring now to the Figures, FIG. 1 is an illustration of two non-integrated luminaires 100, 200 arranged in a horticultural environment HE. The horticultural environment HE may be any enclosed area for growing plants P1-P3, such as a greenhouse, grow room, growth chamber, or other indoor and/or enclosed agricultural space. The plants P1-P3 may be any type of plant capable of growing in an indoor or enclosed environment. The upper edge of the group of plants P1-P3 may be referred to as a plant canopy PC. These indoor and/or enclosed horticultural environments HE rely on light generated by the light sources 102, 202 of the non-integrated luminaires 100, 200 to facilitate plant growth via photosynthesis. In some examples, these light sources 102, 202 may include one or more light emitting diodes (LEDs) or high-pressure sodium (HPS) lights. Thus, the non-integrated luminaires 100, 200 may be colloquially referred to as “grow lights.”

The light generated by the non-integrated luminaires 100, 200 also creates a significant amount of undesirable heat within the horticultural environment HE. This heat must be countered by the various internal systems of the horticultural environment HE, such as a heating, ventilation, and air conditioning (HVAC) system. Some estimates show that 50% (in the case of LEDs) to 62% (in the case of HPS lights) of heat generated by grow lights may be trapped within the horticultural environment HE. This excess heat must be removed by the HVAC system to prevent harmful heat-related stress effects to the plants, and may be considered the “cooling load” of the HVAC system. Further, asynchronous changes in light-temperature regimes within the horticultural environment HE can impact plant processes (such as metabolism) at a molecular level, while also affecting morphological traits (such as root-to-shoot ratio). Even further, research has shown that heat-related plant stress is most noticeable under fixed light conditions in combination with variable temperatures. Thus, growers should avoid applying constant levels of light in a fluctuating temperature environment. Additionally, the energy required to remove the excess heat from the horticultural environment HE leads to higher energy costs and a larger carbon footprint.

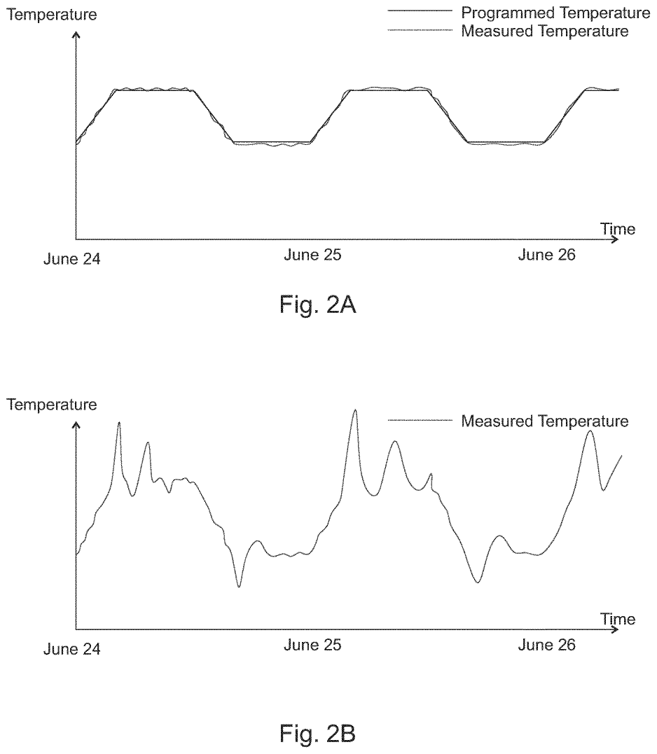

Large farming operations typically utilize an integrated system where the HVAC system is in communication with the grow lights (such as via a central controller) in order to reduce overall heat gain and sudden spikes in heat while still providing sufficient light for plant growth. However, such integrated systems are often too expensive for home and small growing operations. In the case of small farming operations, such as the horticultural environment HE of FIG. 1, the non-integrated luminaires 100, 200 provide light to the plants P1-P3 independent of the HVAC system (or other systems of the horticultural environment HE). Due to the legalization and/or decriminalization of cannabis throughout the United States, the market for greenhouses is expected to reach 413 hectares by the year 2025, while the market for home and small growers is expected to reach 477 hectares in the same timeframe. The non-integrated luminaires 100, 200 within these home and small growing operations are often scheduled to turn on the luminaires at full capacity without considering the effects on HVAC cooling load and plant heat stress. The results of integrated vs. non-integrated systems are shown in FIGS. 2A and 2B. FIG. 2A compares programmed temperature to measured temperature in an integrated growing system. As can be seen, the measured temperature closely follows the programmed temperature's day and night setpoints with minimal variance. This can be achieved by coordinating aspects of the HVAC systems and/or other systems with anticipated increases in temperature due to activating the grow lights. Further, integrated systems can quickly adjust to deviations in temperature (and in some cases, humidity) due to receiving rich and detailed information from various aspects of the systems, such as individual sub-systems or sensors. By comparison, FIG. 2B illustrates the measured temperature in a non-integrated growing system. As is clear from FIGS. 2A and 2B, the temperature within the non-integrated growing system suffers from rapid changes in temperatures when grow lights are turned on or off.

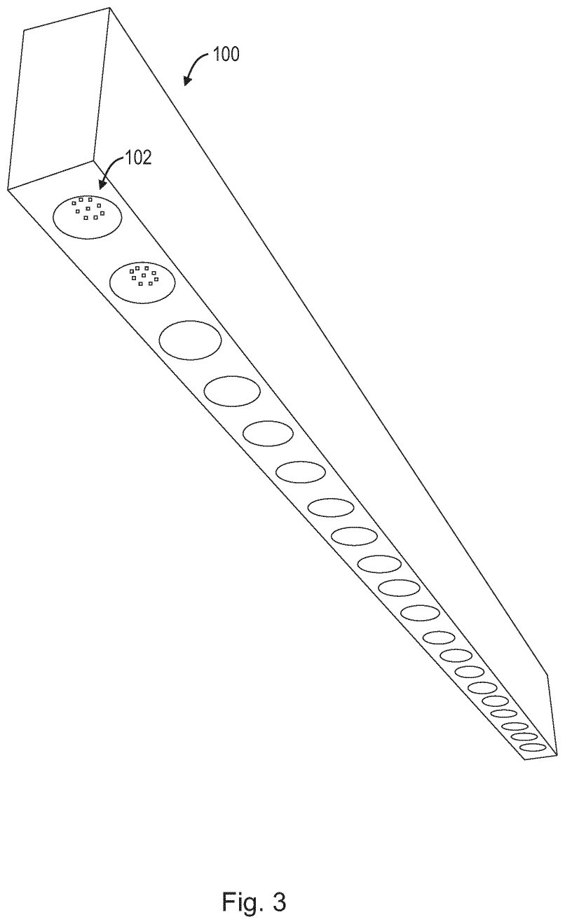

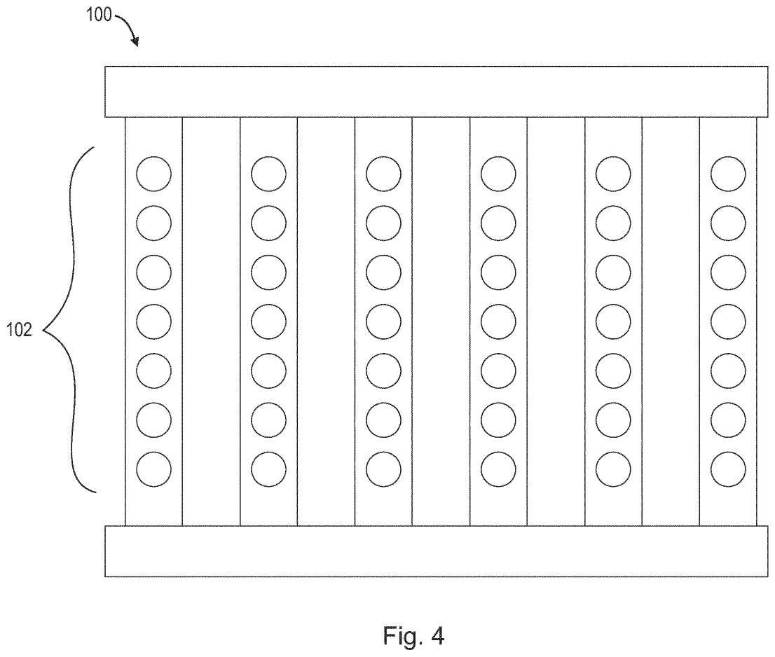

Accordingly, the non-integrated luminaires 100, 200 of FIG. 1 offer an inexpensive (as compared to a fully integrated system), plug-and-play, flexible solution to counteract the rapid changes in temperature shown in FIG. 2B. While the horticultural environment HE of FIG. 1 includes two non-integrated luminaires 100, 200 for illustrative purposes, any practical number of non-integrated luminaires 100, 200 may be used. The non-integrated luminaires 100, 200 may be any practical variety of luminaire, such as the top light depicted in FIG. 3 or the grid light depicted in FIG. 4. While the non-integrated luminaires 100, 200 of FIG. 1 are shown as suspended from the ceiling of the horticultural environment HE, the non-integrated luminaires 100 may be arranged within the horticultural environment HE in any manner practical to provide sufficient illumination to plants P1-P3.

The first non-integrated luminaire 100 includes a plurality of light sources 102 (such as LEDs), and one or more sensors 110. In the example of FIG. 1, the sensors 110 embedded within the first non-integrated luminaire 100 are shown as an ambient temperature sensor 112, and a plant temperature sensor 116. The example first non-integrated luminaire 100 also includes fourteen light sources 102a-n. Any practical number, size, shape, or variety of light sources 102 may be used. The ambient temperature sensor 112 is configured to measure the ambient air temperature of the horticultural environment HE. Similarly, the plant temperature sensor 116 is configured to measure the temperature at plants P1-P3. In some examples, the plant temperature sensor 116 may be a thermal camera, a single pixel thermopile (SPT) sensor, or a multi-pixel thermopile (MPT) array.

While the example ambient temperature sensor 112 and the plant temperature sensor 116 are depicted as embedded within the first non-integrated luminaire 100, in other examples, the sensors 112, 116 may be positioned externally to the non-integrated luminaire 100. For example, the ambient temperature sensor 112 may be suspended from the ceiling of the horticultural environment HE, while the plant temperature sensor 116 may be arranged proximate to plant P1. In these examples, the ambient temperature sensor 112 and/or the plant temperature sensor 116 may convey measured data to the first non-integrated luminaire 100 via a wired (such as powerline) and/or wireless (such as Zigbee, Bluetooth, Wi-Fi, etc.) connection.

FIG. 1 also shows a light sensor 132 arranged proximate to a first plant P1 and a second plant P2. The light sensor 132 is configured to measure the amount of light received by the plants P1, P2. In some examples, the light sensor 132 may be a multi-spectral camera configured for multiple frequency bands, including visible (including red-green-blue (RGB) light spectra) and near infrared (NIR) light spectra. In other examples, the light sensor 132 may be a photosynthetically active radiation (PAR) sensor. The light sensor 132 is further configured to convey data to the first non-integrated luminaire 100 via a wired (such as powerline) and/or wireless (such as Zigbee, Bluetooth, Wi-Fi, etc.) connection. In further examples, particularly in the case of a multi-spectral camera, the light sensor 132 may be embedded within the first non-integrated luminaire 100. As a PAR sensor must typically be arranged near the area to be measured, a PAR sensor will not typically be embedded within the first non-integrated luminaire 100. In further examples, the sensors may also include a humidity sensor. The humidity sensor may be configured to generate data related to vapor pressure deficit.

Like the first non-integrated luminaire 100, the second non-integrated luminaire 200 also includes a plurality of light sources 200, such as LEDs, and one or more sensors 210. The second non-integrated luminaire 200 includes an ambient temperature sensor 212 and a light sensor 232, such as a multi-spectral camera. The second non-integrated luminaire 200 also receives data from an external plant temperature sensor 216 via a wired (such as powerline) and/or wireless (such as Zigbee, Bluetooth, Wi-Fi, etc.) connection.

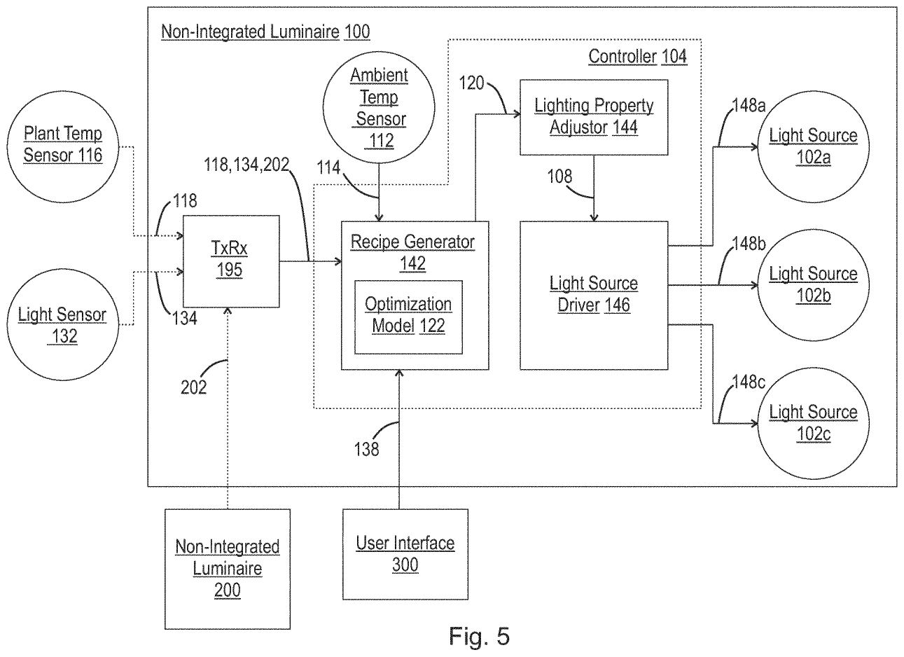

While the first and second non-integrated luminaires 100, 200 are not connected to the various systems (such as the HVAC system) of the horticultural environment HE, they may be communicatively coupled to each other via a wired (such as powerline) and/or wireless (such as Zigbee, Bluetooth, Wi-Fi, etc.) connection. In this way, the first and second non-integrated luminaires 100, 200 may share information such as data measured by the various sensors 100, 200, as well as optimized illumination settings. FIG. 5 is a block diagram of a non-integrated luminaire 100 and related devices. As shown in this non-limiting example, the non-integrated luminaire 100 includes, among other components, light sources 102a-c (such as individual LEDs or arrays or groupings of LEDs), a controller 104, an embedded ambient temperature sensor 112, and a transceiver 195. The controller 104 includes a lighting recipe generator 142, a lighting property adjustor 144, and a light source driver 146. The non-integrated luminaire 100 is also configured to receive information from a plant temperature sensor 116, a light sensor 132, a second non-integrated luminaire 200, and/or a user interface 300. As shown in the example of FIG. 1, the non-integrated luminaire 100 may be arranged within a horticultural environment HE to provide illumination to one or more plants P1-P3 and/or a plant canopy PC.

In the example of FIG. 5, the plant temperature sensor 116 and the light sensor 132 are wirelessly connected to the non-integrated luminaire 100 via transceiver 195. Thus, the transceiver 195 receives plant temperature data 118 (measured and transmitted by the plant temperature sensor 116) and spectral data 134 (measured and transmitted by the light sensor 132). The transceiver 195 then conveys the plant temperature data 118 and the spectral data 134 to the lighting recipe generator 142 of the controller 104. The lighting recipe generator 142 also receives ambient temperature data 114 measured by the ambient temperature sensor 112 embedded within the non-integrated luminaire 100.

The lighting recipe generator 142 is configured to generate an optimized lighting recipe 120 for the non-integrated luminaire 100. The optimized lighting recipe 120 indicates one or more optimized lighting properties to encourage plant growth. In many cases, the optimized lighting recipe 120 balances the illumination output required to facilitate photosynthesis while limiting heat gain within the horticultural environment HE. The optimized lighting recipe 120 may comprise settings for an optimized light spectrum, an optimized light intensity, an optimized spatial location, and/or an optimized light direction. These individual properties will be explained in further detail below.

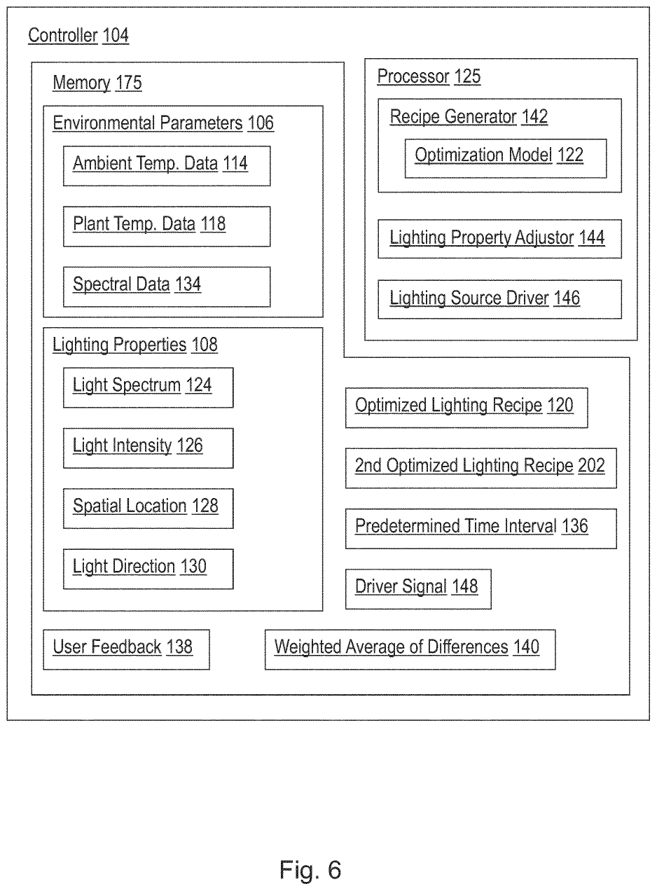

The optimized lighting recipe 120 is generated by feeding one or more measured environmental parameters 106 (see FIG. 6) of the horticultural environment HE into an optimization model 122. The environmental parameters 106 are measured by the various sensors 110 within the horticultural environment HE, and may include sensors 110 embedded within the non-integrated luminaire 100 as well as sensors 110 arranged externally to the non-integrated luminaire 100. In the example of FIG. 5, the one or more environmental parameters 106 include ambient temperature data 114, plant temperature data 118, and spectral data 134. The environmental parameters 106 may be continually measured by the sensors 110 and provided to the controller 104 according to a predetermined time interval 136. For example, the continually measured environmental parameters 106 may be provided to the controller 104 every 30 seconds or any other suitable time interval. In some examples, and as will be explained with further detail below, the optimization model 122 can be a reinforcement learning model configured to determine a weighted average of differences 140 based on the measured environmental parameters 106.

The lighting recipe generator 142 provides the optimized lighting recipe 120 to a lighting property adjustor 144. The lighting property adjustor 144 is configured to adjust one or more lighting properties 108 of the non-integrated luminaire 100. In one example, the lighting properties may include one or more of light spectrum 124, light intensity 126, spatial location 128, and light direction 130. Light spectrum 124 defines the wavelengths of the light provided by the non-integrated luminaire 100. In some examples, the light spectrum 124 may be set to delay or limit infrared wavelengths produced by the light sources 102 during defined periods of illumination, such as when the light sources 102 are initially powered on to reduce stress on the plant canopy PC (see FIG. 1). The light intensity 126 defines the brightness of the light provided by the non-integrated luminaire 100. In some examples, the light intensity 126 may vary across wavelength in order to reduce heat gain in the horticultural environment HE and observed stress on the plants P1-P3. The spatial location 128 defines the intended destination location (such as a specific volume of the plant canopy PC) of the light generated by the non-integrated luminaire 100. The spatial location 128 may be controlled by activating or deactivating individual light sources 102 of the non-integrated luminaire 100. For example, if the non-integrated luminaire 100 is embodied as the grid light of FIG. 4, the spatial location 128 may be controlled by turning on or off individual light sources 102. The light direction 130 defines the direction of the light generated by each light source 102 of the non-integrated luminaire 100. For example, as shown in the example of FIG. 3, each light source 102 of the top light non-integrated luminaire 100 includes a plurality of LEDs. Each of the plurality of LEDs may be controlled (activated or deactivated) individually in order to generate a desired light direction 130. In some examples, the light sources 102 may be pixelated LED arrays, where each pixel of the LED array is individually controllable.

The adjusted lighting properties 108 are provided to a light source driver 146. The light source driver 146 is a circuit configured to generate one or more drive signals 148 to power the light sources 102 such that the light generated by the non-integrated luminaire 100 corresponds to the optimized lighting recipe 120. In the example of FIG. 5, the light source driver 146 generates three drive signals 148a-c, one for each light source 102a-c, respectively. In further examples, additional drive signals 148 may be generated for individual LEDs of the light sources 102 for more detailed control.

In some examples, the non-integrated luminaire 100 is configured to receive a second optimized lighting recipe 202 from a second non-integrated luminaire 200 via a wired or wireless connection. In the example of FIG. 5, the second non-integrated luminaire 200 wirelessly transmits the second optimized lighting recipe 202, which is received by the non-integrated luminaire 200 via the transceiver 195. The transceiver 195 provides the second optimized lighting recipe 202 to the recipe generator 142. The recipe generator 142 may then use the second optimized lighting recipe 202 as part of a computation to determine the optimized lighting recipe 120. In one example, the recipe generator 142 may generate an initial optimized lighting recipe 120 based on the measured sensor data 106 (ambient temperature data 114, plant temperature data 118, and/or spectral data 134), and then adjust the optimized lighting recipe 120 to more closely correlate with the second optimized lighting recipe 202. In other examples, the second non-integrated luminaire 200 may provide other types of data, such as measured environmental parameters or lighting properties.

In a further example of using optimized lighting recipes from other non-integrated luminaires, the non-integrated luminaire 100 may be in wireless communication with four other non-integrated luminaires 200, 300, 400, 500. At a regular time interval (such as five, ten, or fifteen minutes), the first non-integrated luminaire 100 generates a first optimized lighting recipe 120 based on the environmental parameters 106 measured by the sensors 110 associated with the first non-integrated luminaire 100. As previously described, the environmental parameters 106 may include, according to an example, ambient temperature data 114 or plant temperature data 116, while the first optimized lighting recipe 120 corresponds to a light intensity 126. Similarly, the four other non-integrated luminaires 200, 300, 400, 500 also determine optimized lighting recipes 202, 302, 402, 502. Prior to implementing the optimized lighting recipe 120 via the lighting property adjustor 144 and the light source driver 146, the non-integrated luminaire 100 receives the further optimized lighting recipes 202, 302, 402, 502 via the transceiver 195. The lighting recipe generator 142 may then adjust the optimized lighting recipe 120 based upon the other optimized lighting recipes 202, 302, 402, 502. For example, the lighting recipe generator 142 may perform a majority vote across all of the optimized lighting recipes 120, 202, 302, 402, 502 to set the first optimized lighting recipe 120 to the most popular recipe across the entire system. In this way, outlier and/or erroneous optimized lighting recipes may be effectively ignored by the first non-integrated luminaire 100. In another example, the lighting recipe generator 142 may calculate an average of all of the optimized lighting recipes 120, 202, 302, 402, 502 to set the first optimized lighting recipe 120 to the median recipe across the entire system. In either the majority vote or median examples, certain lighting recipes deemed to be more relevant to the first non-integrated luminaire 100 (such as the optimized lighting recipe 120 calculated by the first non-integrated luminaire and/or optimized lighting recipes 202, 302, 402, 502 corresponding to non-integrated luminaires 200, 300, 400, 500 in close spatial proximity to the first non-integrated luminaire) may be granted more weight in the calculation. Once the optimized lighting recipe 120 is updated to account for the other non-integrated luminaires 200, 300, 400, 500, the lighting property adjustor 144 and the light source driver 146 may apply the update optimized lighting recipe 120 to the light sources 102a-c.

In some examples, the non-integrated luminaire 100 is configured to receive user feedback 138 from a user interface 300. The user feedback 138 may reflect a user's assessment as to the impact of the current lighting regime on the health of the plants P1-P3 within the horticultural environment HE. The user feedback 138 may also reflect a user's assessment of the overall heat gain or cooling load within the horticultural environment HEE. The user may enter the user feedback 138 through any practical user interface 300, such as a touch screen, keypad, microphone, etc. The user interface 300 may be a component of a standalone computing device, such as desktop computer, laptop computer, smartphone, tablet computer, etc. In the example of FIG. 5, the user feedback 138 is provided to the controller 104 via a wired connection. In other examples, the user feedback 138 is provided via wireless connection facilitated by the transceiver 195. The lighting recipe generator 142 may then use the user feedback 138 as part of a computation to determine the optimized lighting recipe 120. In this way, the optimized lighting recipe 120 will reflect, in addition to the measured environmental parameters 106, the observations of a user which may not be sufficiently measured by the sensors 110.

In one example, the optimized lighting recipe 120 is generated by implementing the optimization model 122 as a multi-armed bandit (MAB) problem. In this example, the MAB problem is implemented by setting a number of agents (N), a number of actions (K), and a time step size (t), to quantify a reward of an action k. In this example, the agents represent the non-integrated luminaires 100 in the system, and the actions represent the changes in lighting properties 108. In this specific example, the action refers to reducing light intensity 126 through dimming, though other examples may change one or more other lighting properties 108 (such as light spectrum 124, spatial location 128, and/or light direction 130). Accordingly, this example contemplates a horticultural environment HE with more than one non-integrated luminaire 100.

In this example, the optimization model 122 is initialized by performing each action (dimming step) at least once and capturing the results via the sensors 110 (ambient temperature sensor 112, plant temperature sensor 116, light sensor 132, etc.) to determine the reward at each step. In this example, the time step size should be long enough such that the data captured by the sensors 110 reflects changing in dimming. For example, the time step size, may be five, ten, or fifteen minutes. Further to this example, the reward is defined as a weighted average of differences 140 in plant temperature data 118 and cooling load (corresponding to ambient temperature data 114) based on each action. The weighted average of differences 140 includes or corresponds to a weighted average of differences in values of two or more the measured environmental parameters 106 recorded during modifications of the one or more lighting properties 108. The weighted average of differences value or value determined by computing the weighted average of differences can include or correspond to the values that are averaged according to weights preassigned to the respective environmental parameters 106. The cooling load represents the amount of energy (which may be represented in joules or British thermal units) required to remove excess heat from the horticultural environment HE. The amount of excess heat to be removed may be determined by comparing the ambient temperature to a desired temperature or temperature range for optimized growth in the horticultural environment HE. In other examples, the reward may also be calculated at least in part based on spectral data 134, vapor pressure deficit data, and/or photosynthesis efficiency. In even further examples, the reward may also be calculated at least in part based on user feedback 138. The weighted average of differences 140 may be calculated by first determining the change in the plant temperature data 118 and the cooling load from one action to the next, scaling the calculated changes so that a change in temperature may be meaningfully averaged with a change in cooling load (for example, scaling both temperature and cooling load on a scale of 0 to 100, where a change in plant temperature of 1.5 C scales to 85, and a change in cooling load of 985 J scales to 45), and then averaging the scaled values according to predetermined weights. For example, if stable plant temperature data 118 is more important than stable cooling load, the change in plant temperature data may be assigned a greater weight than the cooling load. Generally, stable plant temperature data 118 and cooling load will result in a positive reward, while significant changes in plant temperature data and/or cooling load will result in a negative reward. These initialization steps may also be considered the “exploration” stage of the MAB problem.

Further, for each dimming step, an upper confidence bound (UCB) is determined. Generally, the UCB is a parameter that is considered by every player or agent while making their local decisions. UCB is tuned for every problem based on network structure and characteristics. In this example, the UCB reflects the confidence (or probability) that the associated dimming level will result in the reward determined by the first non-integrated luminaire 100 at every other luminaire in the system.

Once initialized, each non-integrated luminaire 100 updates its dimming level at time step t. The optimal dimming level is chosen based on adding (1) the potential estimated reward of each available dimming level and (2) the UCB associated with each available dimming level. The dimming level associated with the highest sum of potential estimated reward and UCB is chosen as the optimal dimming level. Additionally, the reward associated with the current dimming level may be updated based on the measured environmental parameters in the same way that the reward was determined during initialization. Updating the rewards associated with the dimming levels during implementation (also known as exploitation) improves the accuracy of the optimization over time.

Further, prior to implementing the optimal dimming level at each time step t, one of the non-integrated luminaires 100 receives (via a wired or wireless transmission) dimming level information from all of the other non-integrated luminaires. The non-integrated luminaire 100 may then update its optimal dimming level based on the dimming levels from the other non-integrated luminaires. For example, the non-integrated luminaire 100 may perform a majority vote of the dimming levels and chose the most popular dimming level to implement. Further, the non-integrated luminaire 100 may average all of the dimming levels to implement a median dimming level. In these examples, certain dimming levels (such as the dimming level calculated by the non-integrated luminaire 100 itself or dimming levels associated with luminaires in close spatial proximity of the non-integrated luminaire) may be weighted more heavily than others in the majority vote or median calculations. Further, the non-integrated luminaire 100 may also share its optimal dimming level with the other non-integrated luminaries in the system. Once the optimal dimming level has been updated or corrected via majority vote or averaging, the non-integrated luminaire 100 implements the updated or corrected dimming level. These steps are repeated at every time step t until the reward has been maximized, achieving an optimized lighting recipe 120.

Generally, the MAB problem is a reinforcement learning example where an agent needs to make optimized actions while still learning the outcomes. Examples of MAB problems can be observed in real-world situations (such as global positioning system (GPS) route planning, website advertisement placement etc.), especially in gaming and online applications. In an MAB problem, an agent must choose a series of actions in order to maximize its total reward. At the beginning of the process, the agent is fully unaware of rewards for every action and needs to learn through its actions (“exploration”). At later stages, the agent has learned knowledge about rewarding actions which must be leveraged as and when various situations arise (“exploitation”). There are several solutions available to the MAB problem and each of them differ by how they arbitrate between “exploration” and “exploitation” behaviors during problem solving. In the example initialization described above, each non-integrated luminaire explores each dimming level from 0 to 100%. In other example, each non-integrated luminaire may only explore a portion of the dimming levels, and rely on data shared by the other non-integrated luminaires to learn the reward associated with the other dimming levels. In this example, a first non-integrated luminaire may explore dimming levels 0 to 50%, while a second non-integrated luminaire may explore dimming levels 60% to 100%. In some examples, the initial dimming levels of each of the non-integrated luminaires may correspond to a randomly assigned value. For example, the first non-integrated luminaire may be randomly set to a dimming level of 20%, while the second non-integrated luminaire may be randomly set to a dimming level of 60%.

In this example, light-temperature regimes in the horticultural environment HE are modelled as a multi-agent multi-armed bandit problem in a multi-agent network where N agents (non-integrated luminaires 100) sequentially select actions from a finite number of K actions (dimming steps). The N agents also share knowledge with the other non-integrated luminaires 100. Each agent must work towards finding actions with rewards better than what is known in the network of non-integrated luminaires 100. Since each agent can only observe its own reward, agents must pass their knowledge across the network to collaboratively estimate true rewards. Continuing with this example, finding optimal dimming settings for every non-integrated luminaire 100 in a grow room is equivalent to minimizing overall regret (R_{T}) of the luminaire network according to the equation below:

$${R}_{T} := T μ ( 1 ) - {\sum }_{t = 1}^{T} 𝔼 [ μ ( {I}_{t} ) ] = {\sum }_{k = 2}^{K} {Δ}_{1 , k} 𝔼 [ {n}_{T} ( k ) ] \qquad ( 1 )$$

R_{T} represents regret at a given point in time t. Generally, regret is the difference between an expected result (such as a specific temperature) and a measured result. In Equation 1, μ is the expected value of a random variable, [symbol] [⋅] is the expectation operator, t∈[T] is time instant at which arm k is pulled, Iₜ is the random variable that represents the arm that is chosen by player i at time t, Δ_{k,m} is the gap in expected value of true rewards of action (dimming step) pair k and m, K is the finite number of actions (in this case, 20 dimming steps, with each step representing 5% incremental dimming step from 0% to 100% of light output), and n_{T}(k) is the number of times action k (a dimming step) has been chosen as a majority vote by the network until time t. The minimization of regret (R_{T}) is performed using a Distributed Upper Estimated Reward algorithm.

FIG. 6 schematically illustrates a controller 104 of a non-integrated luminaire 100 as depicted in FIG. 5. As illustrated, the controller 104 includes a processor 125 and a memory 175. The memory 175 can be configured to store a plurality of environmental parameters 106 measured by sensors 110 (see FIG. 1), including ambient temperature data 114, plant temperature data 118, and spatial data 134. The memory 175 may also store a predetermined time interval 136 representing the timing of when the measurements taken by the sensors 110 are provided to the controller 104. The memory 175 can be further configured to store user feedback 138 received via a user interface 300 (see FIG. 5) and a second optimized lighting recipe 202 received from a second non-integrated luminaire 200 (see FIG. 5). The processor 125 executes a lighting recipe generator 142 to generate an optimized lighting recipe 120 by processing the environmental parameters 106 through an optimization model 122. The recipe generator 142 may also factor in the user feedback 138 and/or the second optimized lighting recipe 202 in generating the optimized lighting recipe 120. The processor 125 then executes a lighting property adjustor 142 to adjust one or more lighting properties 108 stored in memory 175 based on the optimized lighting recipe 120. The processor 125 then executes the lighting source driver 146 to generate driver signals 148 for each light source 102 (see FIG. 5) based on the adjusted lighting properties 108. The controller 104 then provides the driver signals 148? to the light sources 102, resulting in the non-integrated luminaire 100 illuminating according to the optimized lighting recipe 120. When new environmental parameters 106 are measured at the next time stamp or at the next time interval, the process may begin again, and a new optimized lighting recipe 120 may be generated.

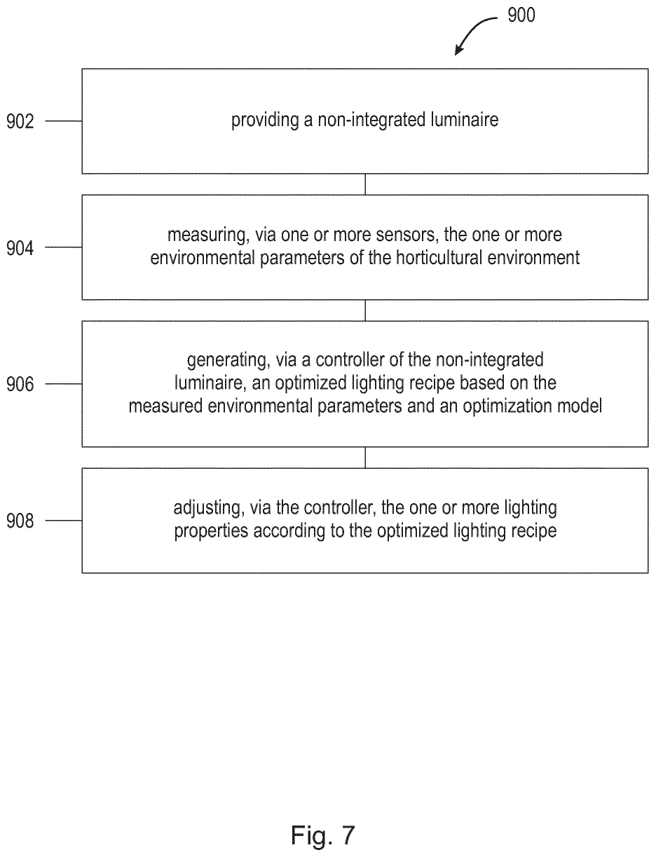

FIG. 7 illustrates a method 900 of illuminating a horticultural environment with one or more non-integrated luminaires. The method 900 includes providing 902 the one or more non-integrated luminaires. The non-integrated luminaire includes one or more light sources to provide illumination and influence one or more environmental parameters of the horticultural environment based on one or more lighting properties of the illumination. The non-integrated luminaire further includes a controller communicatively coupled to one or more sensors configured to measure the one or more environmental parameters. The one or more sensors include at least one of an ambient temperature sensor configured to measure ambient temperature data or a plant temperature sensor configured to measure plant temperature data. The one or more sensors may also include a light sensor configured to measure spectral data.

The method 900 further includes measuring 904, via the one or more sensors, the one or more environmental parameters of the horticultural environment. The method 900 further includes generating 906, via the controller, an optimized lighting recipe based on the measured environmental parameters and an optimization model. The optimization model is configured to compute a weighted average of differences based on the measured environmental parameters recorded during modifications of the one or more lighting properties. The optimization model may be a reinforcement learning model. The method 900 further includes adjusting 908, via the controller, the one or more lighting properties according to the optimized lighting recipe.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A non-integrated luminaire arranged in a horticultural environment (HE), comprising:
one or more light sources configured to provide illumination and influence one or more environmental parameters of the horticultural environment (HE) based on one or more lighting properties; and
a controller communicatively coupled to one or more sensors-configured to measure the one or more environmental parameters, the one or more sensors including at least one of an ambient temperature sensor configured to measure ambient temperature data or a plant temperature sensor configured to measure plant temperature data, the controller configured to:
generate an optimized lighting recipe based on the measured environmental parameters and an optimization model, wherein the optimization model is configured to compute a weighted average of differences in values of two or more of the measured environmental parameters recorded during modifications of the one or more lighting properties, wherein the weighted average of differences values are averaged according to weights preassigned to the respective measured environmental parameters; and
adjust the one or more lighting properties according to the optimized lighting recipe.

2. The non-integrated luminaire of claim 1, wherein at least one of the one or more light sources is a light emitting diode (LED) or a high-pressure sodium (HPS) light.

3. The non-integrated luminaire of claim 1, wherein the one or more lighting properties comprise a light spectrum, a light intensity, a spatial location, and/or a light direction.

4. The non-integrated luminaire of claim 3, wherein at least one of the one or more lighting properties is wavelength dependent.

5. The non-integrated luminaire of claim 1, wherein the plant temperature sensor is a thermal camera, single pixel thermopile sensor, or a multi-pixel thermopile array.

6. The non-integrated luminaire of claim 1, wherein the optimization model is a reinforcement learning model.

7. The non-integrated luminaire of claim 1, wherein the one or more sensors includes a light sensor configured to measure spectral data.

8. The non-integrated luminaire of claim 7, wherein the light sensor is a multi-spectral camera or a photosynthetically active radiation (PAR) sensor.

9. The non-integrated luminaire of claim 1, wherein the controller is further configured to receive, via a wired or wireless connection, a second optimized lighting recipe from a second non-integrated luminaire.

10. The non-integrated luminaire of claim 9, wherein the adjusting of the one or more lighting properties is further based on the second optimized lighting recipe.

11. The non-integrated luminaire of claim 9, wherein the controller is further configured to transmit, via the wired or wireless connection, the optimized lighting recipe to the second non-integrated luminaire.

12. The non-integrated luminaire of claim 1, wherein the non-integrated luminaire is a top light or a grid light.

13. The non-integrated luminaire of claim 1, wherein the one or more environmental parameters are provided to the controller according to a predetermined time interval.

14. The non-integrated luminaire of claim 1, wherein the optimized lighting recipe is generated further based on user feedback received by the controller.

15. A method of illuminating a horticultural environment, comprising:
providing a non-integrated luminaire, wherein the non-integrated luminaire comprises:
one or more light sources to provide illumination and influence one or more environmental parameters of the horticultural environment based on one or more lighting properties; and
a controller communicatively coupled to one or more sensors configured to measure the one or more environmental parameters, the one or more sensors including at least one of an ambient temperature sensor configured to measure ambient temperature data or a plant temperature sensor configured to measure plant temperature data;
measuring, via the one or more sensors, the one or more environmental parameters of the horticultural environment;
generating, via the controller, an optimized lighting recipe based on the measured environmental parameters and an optimization model, wherein the optimization model is configured to compute a weighted average of differences in values of two or more of the measured environmental parameters recorded during modifications of the one or more lighting properties, wherein the weighted average of differences values are averaged according to weights preassigned to the respective measured environmental parameters; and
adjusting, via the controller, the one or more lighting properties according to the optimized lighting recipe.
